(19) United States
(12) Patent Application Publication
(10) Pub. No.: US 2001/0011820 A1
(43) Pub. Date: Aug. 9, 2001

(54) Magazine booklet

(76) Inventor: Dante R. Olivar, Quezon City (PH)

Correspondence Address: ROBERT CHAVEZ, 30 MARGARITA TERRACE, NOVATO, CA, 94947, US

(21) Appl. No.: 09/776,727

(22) Filed: Feb. 6, 2001

(30) Foreign Application Priority Data
Feb. 9, 2000 (PH) 2-2000-00058

(51) Int. Cl. G09F 1/00

(52) U.S. Cl. 283/56; 283/63.1; 283/64; 281/22; 281/15.1

(57) ABSTRACT

The present invention discloses a magazine booklet being used primarily as an advertising and promotional vehicle at the same time contains information such as news, TV, and movie guides, sports, entertainment and the like. Said magazine booklet comprises an elongated body having a plurality of attached pages wherein each page is divided into three parts, the middle portion thereof being allotted for said information while the opposing top and bottom portions are allotted for advertisements, promotions and the like.

### FIELD OF INVENTION

The present invention relates in general to magazines, but more particular to a magazine booklet having a format that contains news items, entertainment and sports news, TV programs, movies and the like.

### BACKGROUND OF THE INVENTION

Current newspapers and magazines' large size becomes a burden to advertisers because they often occupy the whole page just to promote their products and be noticed. This kind of strategy, however, is very costly since it needs more paper space, and ink to satisfy the advertising requirement. Also, small advertisers could hardly afford the high cost of promoting their products using the current advertising strategy. Furthermore, these large sized newspapers or magazines are very inconvenient to bring and read in tight places such as commuter trains, buses and other crowded areas.

### SUMMARY OF THE INVENTION

The primary object of this invention therefore is to provide a magazine booklet that is elongated, hence, very handy and could be read in any place whether crowded or not.

Another object of this invention is to provide a magazine booklet with its pages thereof having a uniform format, hence, printing becomes simple and economical.

Still an object of this invention is to provide a magazine booklet whereby each page consists of information such as news and sports, entertainment and travel guide, business, money matters and the like disposed at the center and the opposing spaces thereof, being allotted for advertisements.

Yet, an object of this invention model is to provide a magazine whereby the small companies could advertise their products in a space the size of which being the same with those of big companies. In this booklet, the small companies therefore will be paired equally with the big companies in terms of advertising space.

A further object of this invention is to provide a magazine booklet that serves as a promotions vehicle wherein companies, especially the small ones could be given the chance to have their products known here and abroad.

These and other objects and advantages will come to view and be understood upon a reading of the detailed description when taken in conjunction with the accompanying drawings.

### DESCRIPTION OF THE SEVERAL VIEWS OF THE DRAWING

FIG. 1 is the perspective view of the magazine booklet according to the present invention; and

FIGS. 2 to 4 are plan views of the same invention with pages open showing the arrangement of the contents thereof.

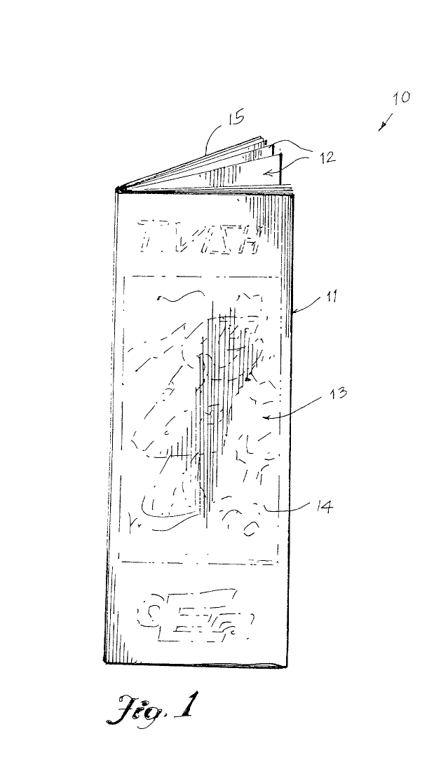

### DETAILED DESCRIPTION OF THE INVENTION

Referring now to several views of the drawing wherein like reference numerals designate same parts thereof, there is shown a magazine booklet generally designated as reference numeral 10.

Said magazine booklet comprises a generally elongated body 11 being defined by a plurality of attached folded sheets 12, the outer sheet 13 of which serving as the front cover 14 and the back cover 15 thereof.

The four (4) pages 16 resulting from the folding of the sheets 12 are each divided into three (3) parts wherein the center portion 17 contains information 18 and the opposing parts, i.e. the upper and lower portions 19 and 20 are reserved for advertisements of products and the like. All pages 16 of the said booklet 10 have the same format throughout.

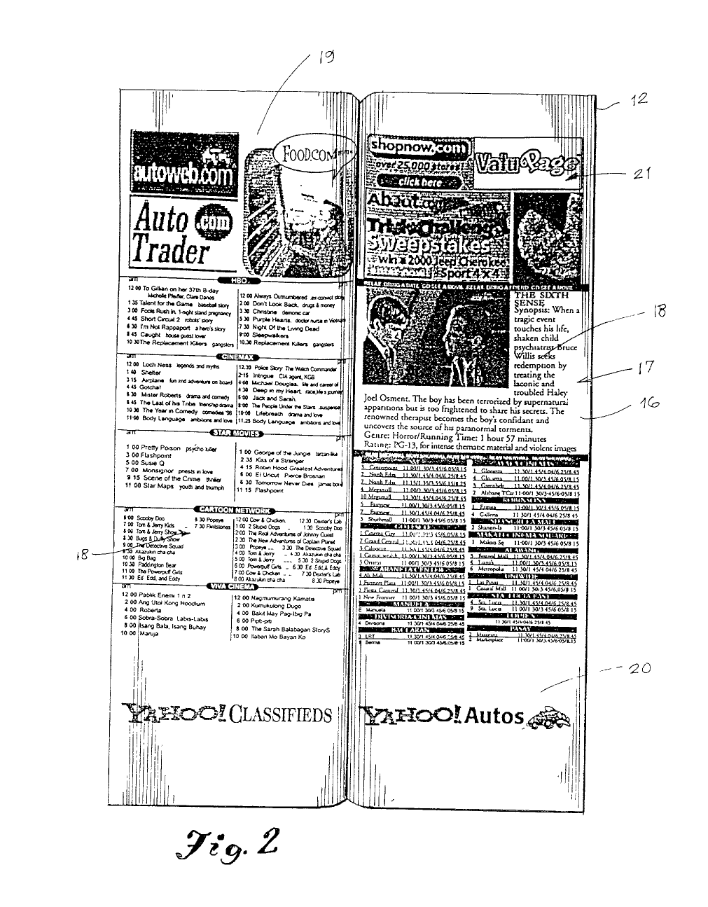

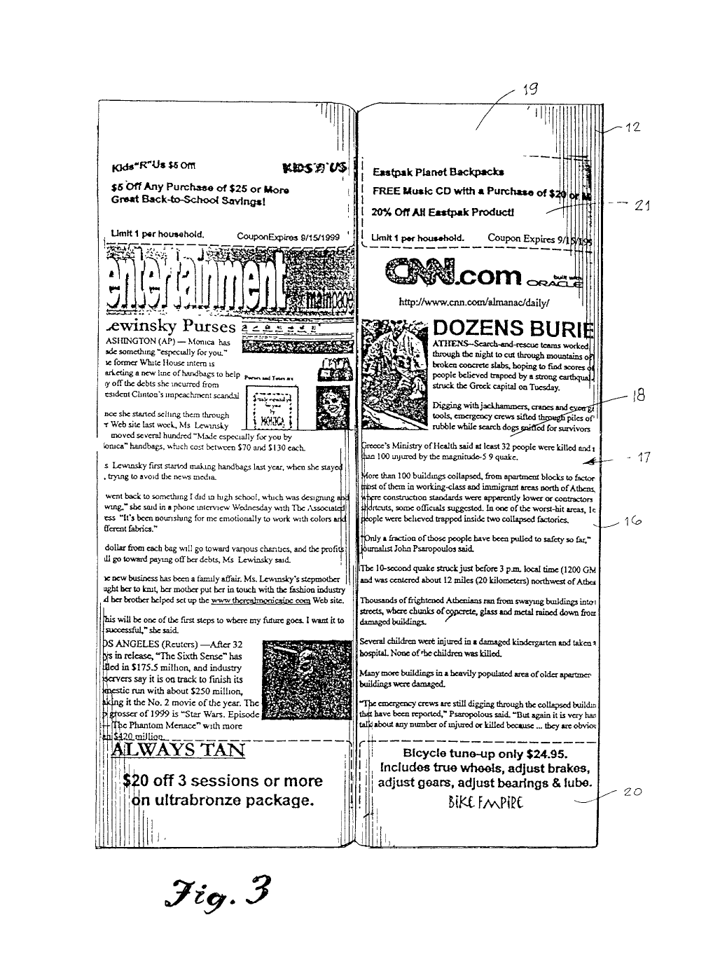

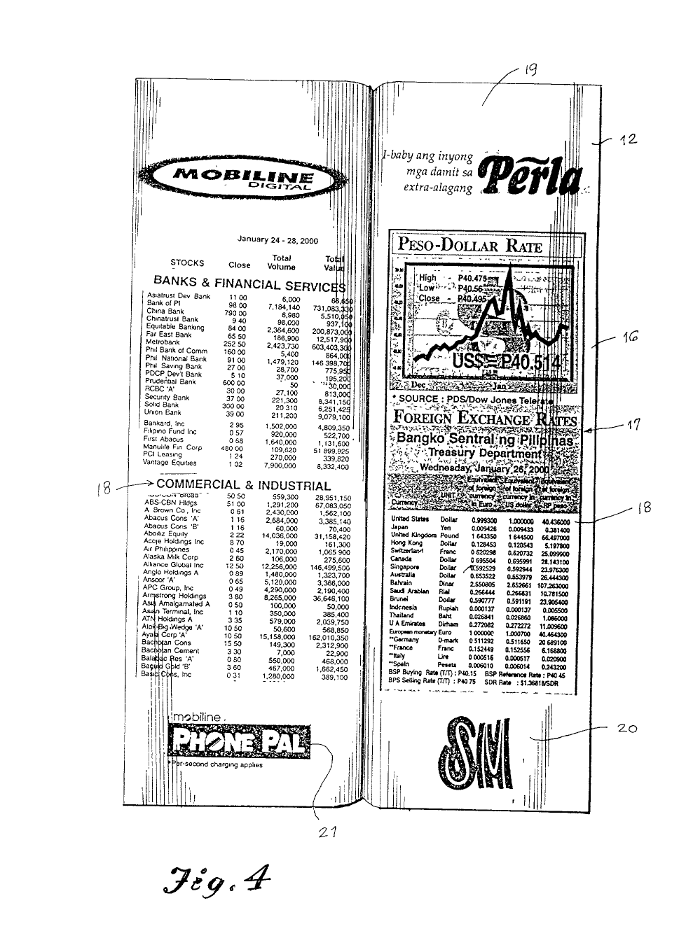

AS shown in FIG. 2, a page 16 contains information 18 such as TV and movie program guides while the opposing ends shows some product advertisements 21. Similarly in FIG. 3, a page 16 contains some news items such as local and foreign news, while, FIG. 4, shows a page 16 containing business and money matters. Other pages may contain sports news, food and health tips, entertainment and fashion news, travel guide, and other items.

1. A magazine booklet comprising a generally elongated body having a plurality of attached folded sheets, with a front and back cover thereof, each of said sheet defining at least four (4) pages, with each page being divided into three (3) parts, a space for information disposed at the central portion of the said page and a pair of opposing spaces for advertisements provided at the upper and lower ends of said pages.

2. A magazine booklet according to claim 1 wherein said information relates to local, foreign and sports news.

3. A magazine booklet according to claim 1 wherein said information relates to TV, movies and travel guides.

4. A magazine booklet according to claim 1 wherein said information relates to business and money matters.

5. A magazine booklet according to claim 1 wherein said information relates to food and health guide.
